(19) United States
(12) Patent Application Publication
(10) Pub. No.: US 2012/0243394 A1
(43) Pub. Date: Sep. 27, 2012

(54) WIRELESS OPTICAL DISC APPARATUS AND METHOD OF OPERATING THE SAME

(76) Inventors: Hoo-seung Lee, Seoul (KR); Soon-gyu Jeong, Suwon-si (KR); Young-woo Lee, Suwon-si (KR)

(21) Appl. No.: 13/403,502

(22) Filed: Feb. 23, 2012

(30) Foreign Application Priority Data
Mar. 24, 2011 (KR) 10-2011-0026459

(51) Int. Cl. G11B 31/00

(52) U.S. Cl. 369/69; G9B/31

(57) ABSTRACT

A wireless optical disc apparatus includes an optical disc drive; a communication unit that is configured to communicate with a wireless terminal device; and a controller connected to the optical disc drive and the communication unit, and the controller is configured to control the optical disc drive.

### CROSS-REFERENCE TO RELATED PATENT APPLICATION

This application claims the benefit of Korean Patent Application No. 10-2011-0026459, filed on Mar. 24, 2011, in the Korean Intellectual Property Office, the entire disclosure of which is incorporated herein in by reference for all purposes.

### BACKGROUND

1. Field

The present disclosure relates to a wireless optical disc apparatus having a wireless networking function and a method of driving the same.

2. Description of the Related Art

Optical disc apparatuses are used as the main source of apparatuses that allow contents to be reproduced. For example, optical disc apparatuses are prominent contents reproducing apparatuses. Optical disc apparatus may be installed in computers. An optical disc apparatus is connected to a host apparatus through various types of embedded or external interfaces.

An embedded interface and an external interface of an optical disc apparatus respectively have wired connection structures. The wired connection structures are main components of the optical disc apparatuses having an embedded and/or an external interface. Examples of an interface by which an optical disc apparatus is connected a host apparatus include an advanced technology attachment (SATA) type and universal serial bus (USB) type. Thus, there is a need for interfaces that are adaptively and widely used. In addition, there is a need to expand use of interfaces.

### SUMMARY

In one general aspect, there is provided a wireless optical disc apparatus. The wireless optical disc apparatus includes an optical disc drive, a communication unit that is configured to communicate with a wireless terminal device, and a controller connected to the optical disc drive and the communication unit, the controller being configured to control the optical disc drive.

The wireless optical disc apparatus may also include access point unit which includes a switch that shares an Ethernet physical layer and network that are connected to an external wide area network (WAN).

The communication unit may include a wired module.

The wireless optical disc apparatus may be such that if an external host device is connected to the wired module, the controller stops controlling the optical disc drive, and the wired module is connected directly to the optical disc drive.

The communication unit may include a wireless module that supports at least one of UPnP, UPnP AV, and DLNA protocols.

The wired module may support a universal serial bus (USB) protocol.

The wireless module may support at least one of WiFi and Bluetooth.

The communication unit may include a wireless module that supports at least one of WiFi and Bluetooth.

In another aspect, there is provided a wireless optical disc apparatus. The wireless optical disc apparatus includes an optical disc drive, a communication unit that is configured to communicate with a wireless terminal device, an external storage device connected to the wireless optical disc apparatus, and a controller connected to the optical disc drive and the communication unit, the controller being configured to control the optical disc drive and the external storage device.

The controller may back up data stored on the external storage device by using the optical disc drive.

The wireless terminal may store an application that controls an operation of backing up the data stored on the external storage device.

The communication unit may include a wireless module that supports at least one of WiFi and Bluetooth.

The wireless optical disc apparatus of may include a power controller that is configured to control power supplied to the controller based on whether a wired terminal is operatively connected to the wireless optical disc apparatus.

In another aspect, there is provided a method of driving a wireless optical disc apparatus that includes an optical disc drive; a communication unit that is configured to communicate with a wireless terminal device; and a controller that is connected to the optical disc drive and the communication unit, and that controls the optical disc drive. The method includes wirelessly receiving data related to an optical disc drive from the wireless terminal device, using a wireless module, determining whether the data is capable of being processed, processing the data and operating the optical disc drive; and transmitting a result obtained by operating the optical disc drive, using the wireless module, wherein when the data is not capable of being processed, the data is converted into data that is capable of being processed, using a controller connected to the wireless module.

The method may include driving a wireless optical disc apparatus that further includes an access point unit comprising a switch that shares an Ethernet physical layer and network that are connected to an external wide area network (WAN). A plurality of wireless terminal devices may be connected through the access point unit.

The data stored on an external storage device may be backed up to the optical disc drive by using the controller.

The data stored on an external storage device may be backed up to the optical disc drive by using the controller.

The wireless terminal device may store an application that controls an operation of backing up data stored on the external storage device.

The method includes driving the wireless optical disc apparatus, which may be configured such that, if a wired module that is configured to control power of the controller is connected to the optical disc drive, and if the wired module is connected to an external host device, then the controller stops controlling the optical disc drive when the optical disc driver is connected to an external host device through the wired module.

The method includes driving the wireless optical disc apparatus, which may be configured such that, if a wired module that is configured to control power of the controller is connected to the optical disc drive, and if the wired module is connected to an external host device, then the controller stops controlling the optical disc drive when the optical disc driver is connected to an external host device through the wired module.

The method includes driving the wireless optical disc apparatus, which may be configured such that, if a wired module that is configured to control power of the controller is connected to the optical disc drive, and if the wired module is connected to an external host device, then the controller stops controlling the optical disc drive when the optical disc driver is connected to an external host device through the wired module.

In another aspect, there is provided a system for backing up data stored on an external storage device to an optical recording medium. The system may include a wireless terminal device, a wireless optical disc apparatus that includes an optical disc drive, a communication unit that is configured to communicate with the wireless terminal device, a controller that is connected to the optical disc drive and the communication unit, the controller being configured to control the optical disc drive, and a wired module, the external storage device which is connected to the wireless optical disc apparatus through the wired module. The wireless terminal device may have an application stored thereon that transmits backup instructions to the wireless optical disc apparatus.

Other features and aspects may be apparent from the following detailed description, the drawings, and the claims.

### BRIEF DESCRIPTION OF THE DRAWINGS

FIG. 1 is a drawing illustrating an example of a wireless optical disc apparatus.

FIG. 2 is a drawing illustrating an example of a front view of a wireless optical disc apparatus.

FIG. 3 is drawing illustrating an example of a wireless optical disc apparatus.

FIG. 4 is a drawing illustrating an example of a wireless optical disc apparatus.

FIG. 5 is a flowchart illustrating an example of an operation performed through a wireless module in a wireless optical disc apparatus.

FIG. 6 is a flowchart illustrating an example of an operation of exchanging a message and a setup operation in which a WiFi connection is established between a wireless optical disc apparatus 1 and a wireless terminal device.

FIG. 7 is a drawing illustrating an example of a wireless optical disc apparatus including a wide area network (WAN) module and a switch hub and having a function of sharing a network.

FIG. 8 is a diagram illustrating an example of wireless optical disc and a wireless terminal device, which are connected to an external storage device, as the wireless optical disc and the wireless terminal device are being used.

FIG. 9 is a flowchart illustrating an example of an optical disc apparatus being used as a backup device of an external storage device.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following detailed description is provided to assist the reader in gaining a comprehensive understanding of the methods, apparatuses, and/or systems described herein. Accordingly, various changes, modifications, and equivalents of the systems, apparatuses and/or methods described herein will be suggested to those of ordinary skill in the art. Also, descriptions of well-known functions and constructions may be omitted for increased clarity and conciseness.

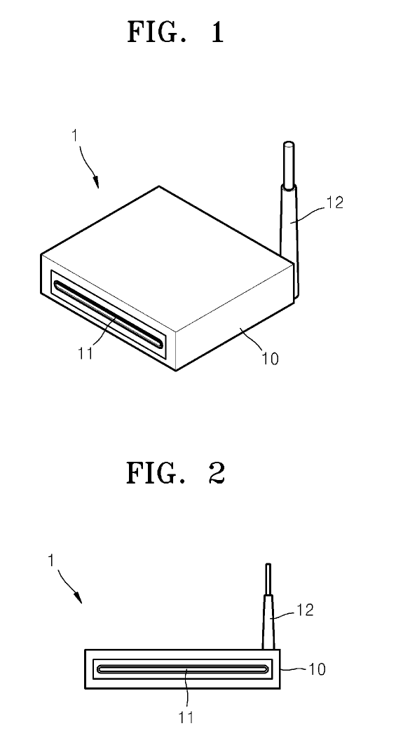

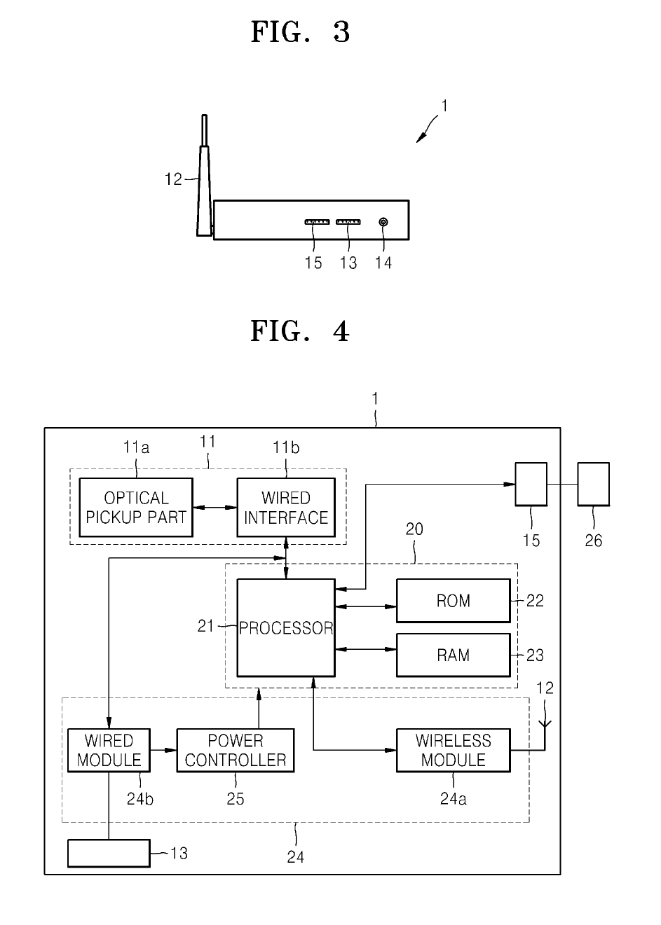

FIG. 1 is a drawing illustrating the schematic perspective view of an example of a wireless optical disc apparatus 1. FIG. 2 is drawing illustrating a front view of an example of a wireless optical disc apparatus 1 such as, for example, the wireless optical disc apparatus illustrated in FIG. 1. FIG. 3 is a drawing illustrating a rear view of an example of a wireless optical disc apparatus 1 such as, for example, the wireless optical disc apparatus illustrated in FIG. 1.

Referring to FIGS. 1 through 3, the wireless optical disc apparatus 1 includes an optical disc drive 11 and a housing 10 that accommodates the optical disc drive 11. As an example, the optical disc drive 11 may be of a built-in type. The wireless optical disc apparatus also includes an antenna 12. The antenna 12 is configured to communicate an external host apparatus. As an example, the antenna 12 may be installed at one side of the housing 10. Alternatively, the antenna 12 may be embedded in the housing 10. As another example, the wireless optical disc apparatus may include two or more antennas.

As a non-limiting example, the wireless optical disc apparatus 1 may be of a tray type or slot-in type.

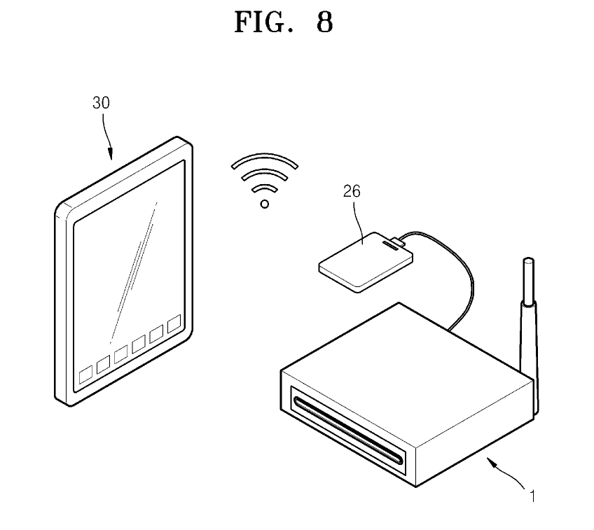

The wireless optical disc apparatus 1 may include an external power connection interface 14. The external power connection interface 14 may be installed (e.g., mounted) at a side of the housing 10. For example, the external power connection interface 14 may be installed (e.g., mounted) at a rear side of the housing 10. The wireless optical disc apparatus 1 may include a wired terminal 13 for a wired connection. The wired terminal 13 may be included in a wired module 24b as described below. The wired terminal 13 may be installed (e.g., mounted) at a side of the housing 10. For example, the wired terminal 13 may be installed (e.g., mounted) at a rear side of the housing 10. The wireless optical disc apparatus 1 may include a socket 15. As an example, socket 15 may include at least one universal serial bus (USB) socket. The socket 15 is configured to connect with an external device. For example, the socket 15 may be configured to connect with a storage device 26 (refer to FIGS. 4 and 8) as an optional component. The socket 15 may be formed at a side of the housing. For example, the socket 15 may be installed (e.g., mounted) at the rear side of the housing 10.

FIG. 4 is a block diagram illustrating an example of a wireless optical disc apparatus 1.

Referring to FIG. 4, the optical disc drive 11 includes an optical pickup part 11 a and a wired interface 11b. The wired interface 11b may be, for example, a serial advanced technology attachment (SATA), USB interface, or the like. As an example, the wired interface 11b may be connected to a controller 20 of the wireless optical disc apparatus 1. The controller 20 may include a processor 21, a read only member (ROM) 22, and a random access memory (RAM) 23. As an example, the controller 20 may be of a system-on-chip type. As an example, the processor 21 may load an operating system (OS) program that is stored in the ROM 22 having a flash memory structure by using the RAM 23 as a buffer memory. The processor 21 may perform data processing, for example, a reading or writing operation. The result may be output. For example, the results may be output through a communication unit 24. The communication unit 24 may include the wireless module 24a or the wired module 24b.

The wireless module 24a of the communication unit 24 may output data provided from the processor 21 or may transmit data containing a command transmitted from an external device to the processor 21.

The wireless module 24a of the communication unit 24 may support a protocol so as to share multimedia data with AV devices in a network. For example, the wireless module 24a of the communication unit 24 may support an UPnP/UPnP AV/DLNA protocol.

The wired module 24b is connected to the wireless optical disc apparatus 1. As an example, the wired module 24b may be connected directly to the wireless optical disc apparatus 1. The wired module may be configured to control an active/inactive state of the controller 20. The wired module 24b is connected to the wired interface 11b. When a user interface cable is connected to the wired terminal 13 such as, for example, a USB terminal connected to the wired module 24b, the wired module 24b detects the connection and stops an operation of the controller 20 so that the optical disc drive 11 may be controlled directly by an external device through the wired module 24b. For example, if the wired module 24b uses a USB interface, the optical disc drive 11 operates an external storage device connected to a host device such as a personal computer through a wired interface cable.

In order to stop an operation of the controller 20, the controller 20 may be turned off. For example, if the wired module 24b uses a USB interface, whether the host device is capable of applying a voltage of 5 volts is detected and a power managing unit (i.e., a power controller) 25 determines whether a voltage is applied to the controller 20. If the host device is not connected to the wired module 24b, the controller 20 is activated by applying a voltage so as to communicate with a wireless terminal device as an external device through the wireless module 24a.

The external storage device 26 is connected to the processor 21 of the controller 20 in order for the optical disc apparatus 1 to use the external storage device 26 in addition to the optical disc drive 11. As an example, the external storage device 26 may be a USB socket device. The USB socket device is connected to the processor 21 of the controller 20 such that the memory stick or a USB memory may be used as the external storage device 26 in addition to the optical disc drive 11. Thus, an external device connected through the wireless module 24a may access an external storage device 26 in addition to the optical disc drive 11. For example, if a memory stick or a USB memory is connected as an external storage device 26, then an external device that is connected through wireless module 24a may access both the external storage device 26 and the optical disc drive 11. The external device may access an external terminal through a protocol such as an Internet small computer system interface (iSCSI), a server message block/common internet file system (SMB/CIFS), or UPnP. Thus, the optical disc drive 11 and the external storage device 26 that provide digital contents may operate based on a signal or other instructions received from the processor 21 as a client source and may input/output data. In other words, the optical disc drive 11 and the external storage device 26 may detect a signal output from the processor 21. The signal may correspond to instructions input by a user. In response to the detected signal, the optical disc drive 11 and the external storage device 26 may input/output data.

Examples of a wireless terminal device that is capable of accessing an external terminal through the wireless module 24a may be a smart television, a computer, a personal digital assistant (PDA), a personal multimedia player (PMP), a tablet personal computer (PC), or a, MP3 player, all of which support wireless communication.

The wireless module 24a that communicates with the above-described wireless terminal device uses a communication protocol for processing data through wireless connection such as WiFi or Bluetooth. Bluetooth version 2.0 or 3.0, or one of versions 1.0/1.1/1.2/2.0/2.1/3.0/4.0, or the like may be used, and WiFi may be WiFi IEEE 802-11g/b/n or WiFi direct.

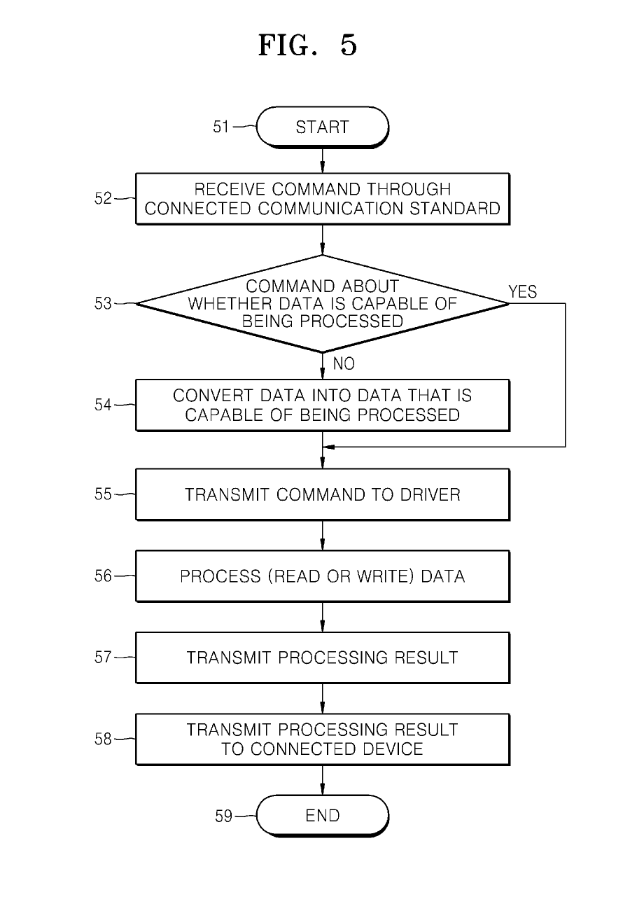

FIG. 5 is a drawing illustrating a flowchart of an example of an operation performed through a wireless module in a wireless optical disc apparatus 1.

When an operation of the wireless optical disc apparatus 1 begins (operation 51), the wireless optical disc apparatus 1 receives a request from a wireless terminal device via a communication protocol corresponding to the wireless module 24a of the communication unit 24 (operation 52).

The received request is interpreted to determine whether data is capable of being processed by the wireless optical disc apparatus 1 or an external storage device (operation 53).

If the data is a command that is capable of being processed by the wireless optical disc apparatus 1 or the external storage device, the command is transmitted directly to the processor 21. If the data is not a command that is capable of being processed by the wireless optical disc apparatus 1 or the external storage device, or the data is not based on a ATA/ATAPI protocol, the data may be converted into a command that is capable of being processed (operation 54) and may be transmitted to the processor 21.

The processor 21 may perform data processing such as a reading or writing operation. For example, the processor 21 may perform data processing by using the optical disc drive 11 or the external storage device 26 according to a command from the wireless module 24a (operation 56). The processor 21 transmits the processing result to a communication unit (operation 57). The communication unit transmits the processing result to a wireless terminal device through a wireless module according to a communication protocol corresponding to the communication unit. Upon communication of the processing result to a wireless terminal device, the data processing may be completed (operation 59).

The wireless module 24a may be connected to the wireless terminal device by a WiFi method. Examples of the WiFi method used by the wireless module 24a may be iSCSI, SMB, or UPnP, as described above. An iSCSI, which is a standard storage networking method, which is performed through TCP ports 860 and 3260. SMB is a protocol using a TCP port 445 and uses common file and printer. UPnP is a technology of connecting and sharing various peripheral devices such as PCs or printers to a home network. UPnP technology uses an Internet relevant protocol such as TCP/IP and dynamic host configuration protocol (DHCP) so that general devices having unique IP addresses may communicate with each other by using an Internet protocol, and is embodied through the extensible markup language (XML). Conventional plug and play may be used to connect a PC to a peripheral device. The general-purpose plug and play method may be extended so as to be also used in a home network.

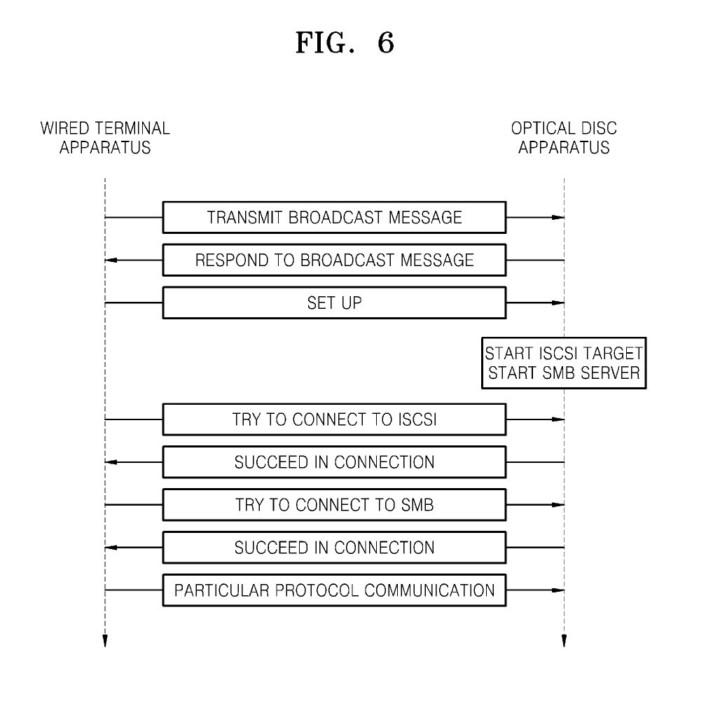

FIG. 6 is a flowchart illustrating an example of an operation of exchanging a message and a setup operation in which a WiFi connection is established between the wireless optical disc apparatus 1 and a wireless terminal device.

A wireless device (or a terminal) transmits a broadcast message for searching for the wireless optical disc apparatus 1. As an example, the transmission of the broadcast message may be broadcast to a plurality of wireless devices. As another example, the broadcast message may be transmitted directly to the wireless optical disc apparatus 1. The wireless optical disc apparatus 1 responds to the broadcast message transmitted from the wireless device. Then, a wireless terminal device sets up the wireless optical disc apparatus 1. For example, the wireless optical disc apparatus 1 starts an operation of an iSCSI target and starts an operation of an SMB server in the presence of an external storage device. Then, the wireless terminal device may be connected to the wireless optical disc apparatus 1 by iSCSI and may be connected to an external device by SMB through a TCP port 3260 so as to exchange protocol specific communications.

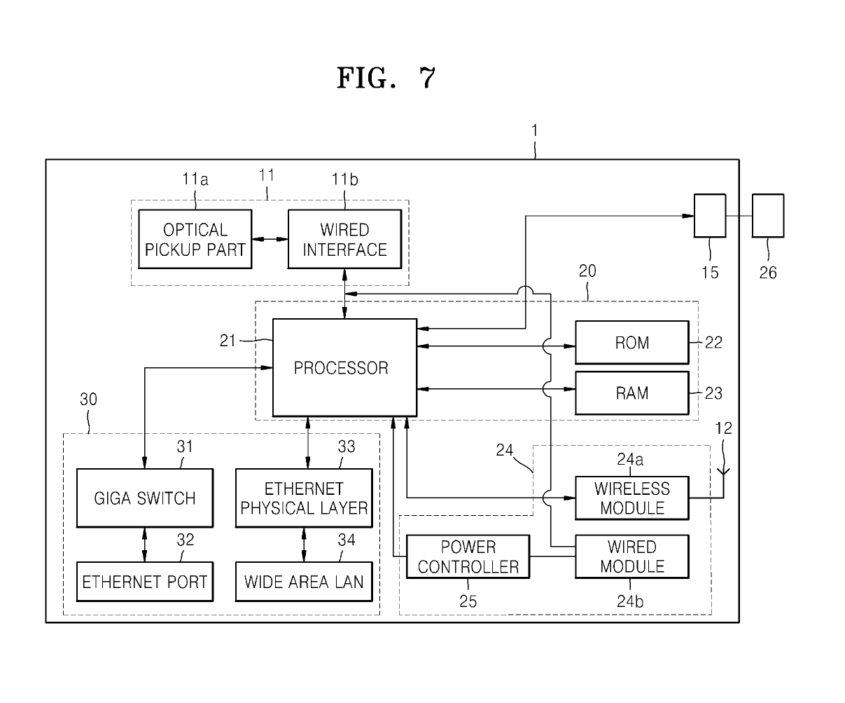

FIG. 7 is a block diagram illustrating an example of a wireless optical disc apparatus 1. As an example, the wireless optical disc apparatus 1 may include a wide area network (WAN) module and a switch hub 25. A wireless optical disc apparatus 1 may be further configured to share a network.

Referring to FIG. 7, an optical disc drive 11 is connected to a controller 20 through an internal wired interface. For example, the optical disc drive 11 may be connected to the controller 20 through a SATA or USB interface. A processor 21 of the controller 20 loads an OS program stored in a ROM 22 by using a RAM 23 as a buffer memory to perform data processing, for example, a reading or wiring operation on the optical disc drive 11. The processor 21 outputs the result through a communication unit 24. The ROM 22 may have a flash memory structure. The communication unit 24 includes a wireless module 24a or a wired module 24b. The wireless module 24a of the communication unit 24 may support an UPnP/UPnP AV/DLNA protocol so as to share multimedia data with AV devices in a network. The optical disc drive 11 operates based on signals the optical disc drive 11 receives from the processor 21. For example, the optical disc drive 11 may receive commands from the processor 21 that are configured to request the optical disc drive 11 to provide digital contents. The optical disc drive 11 may input/output data related to an optical disc. The wireless module 24a outputs data provided from the processor 21 or transmits data containing a command transmitted from a host device to the processor 21. The processor 21 may be connected to an access point module 30. Accordingly, the processor 21 may also process data related to the access point module 30. An Ethernet physical layer (Gigabit PHY) 33 is connected to a wide area LAN port 34 connected to a WAN. In addition, a giga switch 31 that shares a bandwidth assigned by an Ethernet physical layer 33 includes a plurality of Ethernet ports 32. Each Ethernet port 32 may have a structure that is capable of performing wired or wireless connection. Thus, the wireless optical disc apparatus 1 of FIG. 7 is capable of sharing a network and performing a WAN connection as well as of performing a wireless connection. Accordingly, the wireless optical disc apparatus 1 is capable of being widely used with high flexibility.

The wireless optical disc apparatus 1 may be used as a backup device for backing up data of an external device. As shown in FIG. 8, when the external storage device 26, for example, a USB memory, a memory stick, or a hard disc drive, is connected to the wireless optical disc apparatus 1, data stored in the external storage device 26 may be backed up to an optical disc such as, for example, a CD or DVD by using the optical disc drive 11. The wireless terminal device 30 may be configured to communicate with the optical disc apparatus 1 and may be configured to back up data such as, for example, data stored in the external storage device 26. In order to back up data, an application for driving a wireless terminal device 30 may be installed on the wireless terminal device 30. As another example, the wireless terminal device 30 may be configured to communicate with the optical disc apparatus 1 and may be configured to back up data such as, for example, data stored locally on a storage device installed in the wireless terminal device 30.

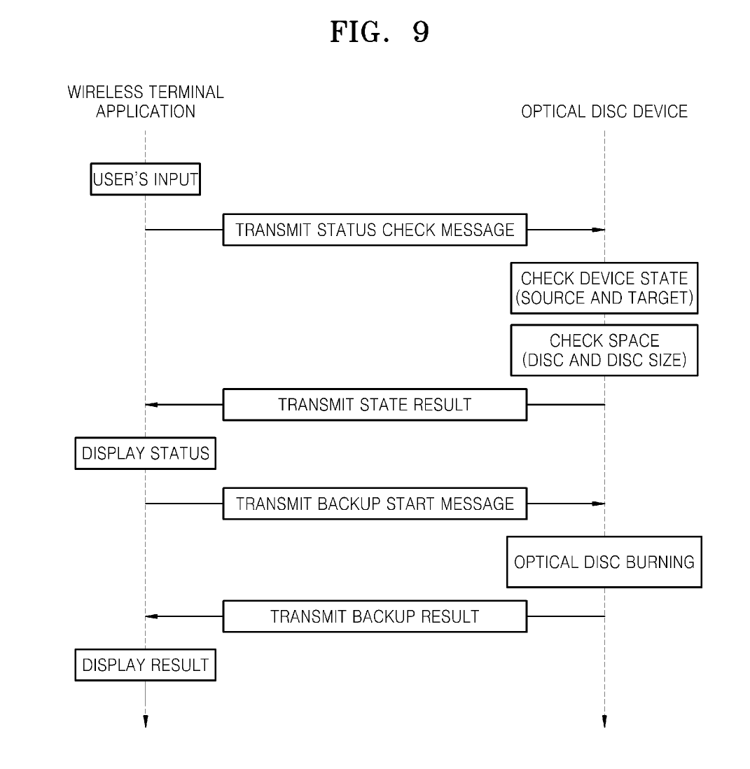

When a backup application is loaded to the wireless terminal device 30, a backup instruction may proceed through a user interface displayed on the wireless terminal device 30. This operation is described below with reference to FIGS. 8 and 9.

When the wireless terminal device 30 and the wireless optical disc apparatus 1 are connected to each other, a user inputs user information for backup initialization by using the backup application. The wireless terminal device and the wireless optical disc apparatus may be connected to each other through WiFi 31. The user information is transmitted as a state check message to the wireless optical disc apparatus 1. A controller of the wireless optical disc apparatus 1 checks a status of an inner system, such as statuses of a source and target, and a space (available volume) status. For example, the operation of checking a state is performed by checking whether the wireless optical disc apparatus 1 is capable of backing up data. As an example, during the operation of checking a status of the wireless optical disc apparatus 1, the controller may check the presence and status of a source such as a USB memory, a memory stick, or a hard disc drive and an optical disc drive for backing up data. Simultaneously, an amount of source data to be backed up is compared with a size of an optical disc inserted into an optical disc drive. The wireless optical disc apparatus 1 transmits the checking result to the wireless terminal device 30. The wireless terminal device 30 displays the checking result on a display. Then, the user may transmit a backup start message through an interface. The wireless optical disc apparatus 1 stores data stored in an external information storage device, in an empty disc, which will be referred to as optical disc burning. When the optical disc burning is completely performed, the wireless optical disc apparatus 1 transmits the result to the wireless terminal device 30 so as to display the result. The optical disc burning from backup start to backup finish may be performed in the wireless optical disc apparatus 1.

A wireless optical disc device may support wireless connection, and thus, spatial and distal limitations of a conventional optical disc device may be overcome, and thus, the wireless optical disc device may be commonly used in a mobile device such as a tablet PC, a smart phone, a PMP, and a PDA or a television as well as in a PC. In addition, the wireless optical disc device may back up data of an external storage device such as a hard disc drive or a semiconductor memory by using an optical disc drive.

According to an aspect, there is provided a wireless optical disc apparatus that shares a wireless network as well as a wireless connection, and a method of driving the same.

According to an aspect, there is provided a wireless optical disc apparatus including an optical disc drive; a communication unit for communicating with a wireless terminal device; and a controller connected to the optical disc driver and the communication unit, and controlling the optical disc drive.

Program instructions to perform a method described herein, or one or more operations thereof, may be recorded, stored, or fixed in one or more computer-readable storage media. The program instructions may be implemented by a computer. For example, the computer may cause a processor to execute the program instructions. The media may include, alone or in combination with the program instructions, data files, data structures, and the like. Examples of computer-readable media include magnetic media, such as hard disks, floppy disks, and magnetic tape; optical media such as CD ROM disks and DVDs; magneto-optical media, such as optical disks; and hardware devices that are specially configured to store and perform program instructions, such as read-only memory (ROM), random access memory (RAM), flash memory, and the like. Examples of program instructions include machine code, such as produced by a compiler, and files containing higher level code that may be executed by the computer using an interpreter. The program instructions, that is, software, may be distributed over network coupled computer systems so that the software is stored and executed in a distributed fashion. For example, the software and data may be stored by one or more computer readable recording mediums. Also, functional programs, codes, and code segments for accomplishing the example embodiments disclosed herein can be easily construed by programmers skilled in the art to which the embodiments pertain based on and using the flow diagrams and block diagrams of the figures and their corresponding descriptions as provided herein. Also, the described unit to perform an operation or a method may be hardware, software, or some combination of hardware and software. For example, the unit may be a software package running on a computer or the computer on which that software is running

A number of examples have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A wireless optical disc apparatus comprising:
an optical disc drive;
a communication unit that is configured to communicate with a wireless terminal device; and
a controller connected to the optical disc drive and the communication unit, the controller being configured to control the optical disc drive.

2. The wireless optical disc apparatus of claim 1, further comprising an access point unit comprising a switch that shares an Ethernet physical layer and network that are connected to an external wide area network (WAN).

3. The wireless optical disc apparatus of claim 1, wherein the communication unit further comprises a wired module.

4. The wireless optical disc apparatus of claim 3, wherein the wireless optical disc apparatus is configured such that if an external host device is connected to the wired module, the controller stops controlling the optical disc drive, and the wired module is connected directly to the optical disc drive.

5. The wireless optical disc apparatus of claim 1, wherein the communication unit includes a wireless module that supports at least one of UPnP, UPnP AV, and DLNA protocols.

6. The wireless optical disc apparatus of claim 3, wherein the wired module supports a universal serial bus (USB) protocol.

7. The wireless optical disc apparatus of claim 5, wherein the wireless module supports at least one of WiFi and Bluetooth.

8. The wireless optical disc apparatus of claim 1, wherein the communication unit includes a wireless module that supports at least one of WiFi and Bluetooth.

9. A wireless optical disc apparatus comprising:
an optical disc drive;
a communication unit that is configured to communicate with a wireless terminal device;
an external storage device connected to the wireless optical disc apparatus; and
a controller connected to the optical disc drive and the communication unit, the controller being configured to control the optical disc drive and the external storage device.

10. The wireless optical disc apparatus of claim 9, wherein the controller backs up data stored on the external storage device by using the optical disc drive.

11. The wireless optical disc apparatus of claim 10, wherein the wireless terminal device stores an application that controls an operation of backing up the data stored on the external storage device.

12. The wireless optical disc apparatus of claim 10, wherein the communication unit includes a wireless module that supports at least one of WiFi and Bluetooth.

13. A method of driving a wireless optical disc apparatus comprising an optical disc drive; a communication unit that is configured to communicate with a wireless terminal device; and a controller that is connected to the optical disc drive and the communication unit, and that controls the optical disc drive, the method comprising:
wirelessly receiving data related to an optical disc drive from the wireless terminal device, using a wireless module;
determining whether the data is capable of being processed;
processing the data and operating the optical disc drive; and
transmitting a result obtained by operating the optical disc drive, using the wireless module,
wherein when the data is not capable of being processed, the data is converted into data that is capable of being processed, using a controller connected to the wireless module.

14. The method of claim 13, wherein the wireless optical disc apparatus further comprises an access point unit comprising a switch that shares an Ethernet physical layer and network that are connected to an external wide area network (WAN), and
wherein a plurality of wireless terminal devices are connected through the access point unit.

15. The method of claim 13, wherein data stored on an external storage device is backed up to the optical disc drive by using the controller.

16. The method of claim 14, wherein data stored on an external storage device is backed up to the optical disc drive by using the controller.

17. The method of claim 16, wherein the wireless terminal device stores an application that controls an operation of backing up data stored on the external storage device.

18. The method of claim 16, wherein the wireless optical apparatus is configured such that, if a wired module that is configured to control power of the controller is connected to the optical disc drive, and if the wired module is connected to an external host device, then the controller stops controlling the optical disc drive when the optical disc driver is connected to an external host device through the wired module.

19. The method of claim 13, wherein the wireless optical apparatus is configured such that, if a wired module that is configured to control power of the controller is connected to the optical disc drive, and if the wired module is connected to an external host device, then the controller stops controlling the optical disc drive when the optical disc driver is connected to an external host device through the wired module.

20. The method of claim 14, wherein the wireless optical apparatus is configured such that, if a wired module that is configured to control power of the controller is connected to the optical disc drive, and if the wired module is connected to an external host device, then the controller stops controlling the optical disc drive when the optical disc driver is connected to an external host device through the wired module.

21. The wireless optical disc apparatus of claim 1, further comprising:
a power controller that is configured to control power supplied to the controller based on whether a wired terminal is operatively connected to the wireless optical disc apparatus.

22. A system for backing up data stored on an external storage device to an optical recording medium, the system comprising:
a wireless terminal device;
a wireless optical disc apparatus comprising
(i) an optical disc drive;
(ii) a communication unit that is configured to communicate with the wireless terminal device;
(iii) a controller that is connected to the optical disc drive and the communication unit, the controller being configured to control the optical disc drive;
(iv) a wired module;
the external storage device which is connected to the wireless optical disc apparatus through the wired module,
wherein the wireless terminal device has an application stored thereon that transmits backup instructions to the wireless optical disc apparatus.
